(19) United States
(12) Patent Application Publication
(10) Pub. No.: US 2012/0303546 A1
(43) Pub. Date: Nov. 29, 2012

(54) STRESS TESTING FINANCIAL INVESTMENTS

(75) Inventors: Steven H. Zhu, New York, NY (US); Brian P. Egal, New York, NY (US)

(73) Assignee: Bank of America Corporation, Charlotte, NC (US)

(21) Appl. No.: 13/115,674

(22) Filed: May 25, 2011

(51) Int. Cl. G06Q 40/00

(52) U.S. Cl. 705/36 R

(57) ABSTRACT

Financial investments may be stress tested to manage risk. To stress test financial investments, a sequence of future economic market events is determined to use to analyze a portfolio, and indices associated with the portfolio are determined. Portfolio data associated with the portfolio is received, and the portfolio data indicates the volatility of the portfolio during a predefined time period. Index data associated with each index of the economic market is received, and the index data indicates the volatility of each index during the predefined time period. A correlation factor associated with the future economic market is determined. Using a processor, a calculated measurement of each index is determined according to the market data, the index data, and the correlation factor. The processor calculates a future index event according to the future market event and the calculated measurement of the index.

### TECHNICAL FIELD OF THE INVENTION

This invention relates generally to financial investments and, more specifically, to stress testing financial investments.

### BACKGROUND

An enterprise may manage portfolios of investments that extend across various asset classes. The enterprise should comply with risk management regulations to manage the portfolios. To comply with the risk management regulations, the enterprise considers various market scenarios that may impact the managed portfolios.

### SUMMARY OF THE DISCLOSURE

In accordance with the present invention, disadvantages and problems associated with stress testing financial investments may be reduced or eliminated.

According to one embodiment of the present invention, stress testing financial investments includes determining a sequence of future economic market events to use to analyze a portfolio, and indices associated with the portfolio are determined. Portfolio data associated with the portfolio is received, and the portfolio data indicates the volatility of the portfolio during a predefined time period. Index data associated with each index of the economic market is received, and the index data indicates the volatility of each index during the predefined time period. A correlation factor associated with the future economic market is determined. Using a processor, a calculated measurement of each index is determined according to the portfolio data, the index data, and the correlation factor. The processor calculates a future index event according to the future market event and the calculated measurement of the index.

Certain embodiments of the invention may provide one or more technical advantages. A technical advantage of one embodiment includes considering future economic market predictions to determine the performance of financial investments under certain market conditions. By considering future prediction information, an enterprise is able to more accurately assess future behavior of a set of financial investments. Another technical advantage of an embodiment includes considering the volatility of indices to more accurately forecast how a portfolio will move in relation to market factors. Additionally, a calculated measurement of the Capital Asset Pricing Model (CAPM) will be used to translate forward looking scenarios and to more accurately forecast the behavior of the tested portfolio. Yet another technical advantage of an embodiment provides a way of performing reverse stress testing on the financial investments to determine the market conditions under which the investment portfolio may be vulnerable. Therefore, information may be calibrated to change the determined profit/loss value of financial investments. Another technical advantage of an embodiment includes considering each portion of the portfolio in the analysis rather than considering the entire portfolio as a whole. To perform the stress testing, the portfolio of financial investments is divided into sub-portfolios to capture the risk more accurately with respect to each market index, and the sub-portfolios are separately analyzed. The analyzed sub-portfolios are then combined to determine the performance of the entire portfolio.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates a system that performs stress testing of financial investments;

FIG. 2 illustrates a particular embodiment of a memory in a stress test module that stores calculated information and stores information used to facilitate stress testing;

FIG. 3 illustrates an example screenshot for displaying results of the stress testing; and

FIGS. 4A-4B illustrate a flowchart for stress testing financial investments.

### DETAILED DESCRIPTION OF THE DRAWINGS

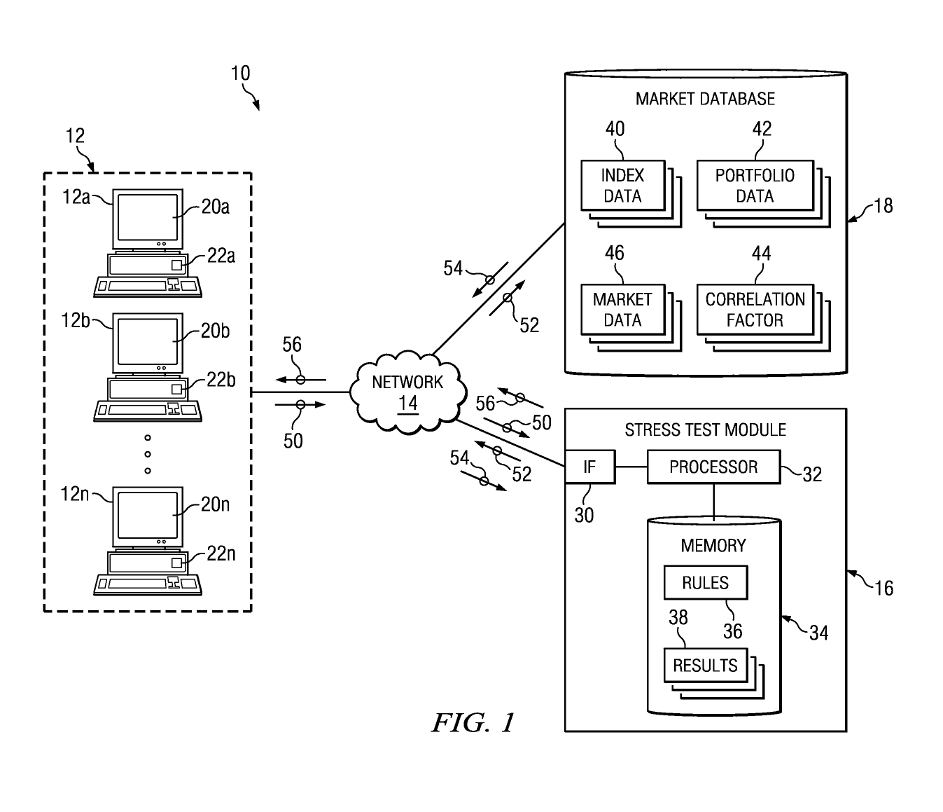

Embodiments of the present invention and its advantages are best understood by referring to FIGS. 1 through 4, like numerals being used for like and corresponding parts of the various drawings.

FIG. 1 illustrates a system 10 that performs stress testing of financial investments. System 10 includes one or more computers 12 that communicate over one or more networks 14 to facilitate stress testing of financial investments. Computer 12 interacts with stress test module 16 to conduct the testing, and stress test module 16 interacts with market database 18 to receive market related information that facilitates the stress testing.

When investing in financial instruments, an enterprise attempts to obtain the highest rate of return for the investment. To get the highest rate of return and to comply with regulations regarding operating capital, the enterprise manages risk associated with changing market conditions and to manage risk to handle an economic shock. In economics, a shock represents an unexpected or unpredictable event that affects an economy, either positively or negatively. Therefore, an enterprise performs risk management analysis on its investments to determine the potential impact of a shock. Part of the risk management analysis includes stress testing the financial investments to determine how the investment will perform in various market conditions. Typical stress testing considers historical market data to determine how the financial investments may perform in the future. The teachings of the disclosure recognize that it would be desirable to consider future economic market predictions to determine how the investment may perform in future unpredictable market conditions.

System 10 includes computers 12a-12n, where n represents any suitable number, that communicate with stress test module 16 through network 14. Computer 12 may include a personal computer, a workstation, a laptop, a wireless or cellular telephone, an electronic notebook, a personal digital assistant, or any other device (wireless, wireline, or otherwise) capable of receiving, processing, storing, and/or communicating information with other components of system 10. A user of computer 12 may request initiation of the stress testing of financial investments. In an embodiment, the stress testing is performed once a fiscal quarter or once a calendar quarter. The user of computer 12 may also submit predefined parameters to stress test module 16 to use in stress testing. Additionally, a user of computer 12 may receive the stress test results in any suitable format on computer 12. Computer 12 may also comprise a user interface, such as a display, a microphone, keypad, or other appropriate terminal equipment usable by a user.

In the illustrated embodiment, computer 12 includes a graphical user interface (“GUI”) 20 that displays information received from stress test module 16 to the user. GUI 20 is generally operable to tailor and filter data entered by and presented to the user. GUI 20 may provide the user with an efficient and user-friendly presentation of information. For example, GUI 20 may display the stress test results in any suitable format such as a bar graph, a pie chart, a line graph, a chart and may display any suitable type of information related to the stress testing results, the investments, or the portfolio. GUI 20 may comprise a plurality of displays having interactive fields, pull-down lists, and buttons operated by the user. GUI 20 may include multiple levels of abstraction including groupings and boundaries. It should be understood that the term GUI 20 may be used in the singular or in the plural to describe one or more GUIs 20 in each of the displays of a particular GUI 20.

Computer 12 also includes an application 22. Application 22 represents any suitable software or logic that allows a user to interact with stress test module 16 by transmitting requests and information to and receiving information from stress test module 16. User 12 may enter access credentials into application 22 to interact with stress test module 16. The access credentials may include a user name and/or a password.

Network 14 represents any suitable network operable to facilitate communication between the components of system 10, such as stress test module 16 and market database 18. Network 14 may include any interconnecting system capable of transmitting audio, video, signals, data, messages, or any combination of the preceding. Network 14 may include all or a portion of a public switched telephone network (PSTN), a public or private data network, a local area network (LAN), a metropolitan area network (MAN), a wide area network (WAN), a local, regional, or global communication or computer network, such as the Internet, a wireline or wireless network, an enterprise intranet, or any other suitable communication link, including combinations thereof, operable to facilitate communication between the components.

Stress test module 16 represents any suitable component that performs stress testing on financial investments to manage risk under various market conditions and to assess the financial health of the investments. Stress test module 16 may include a network server, any suitable remote server, a file server, or any other suitable device operable to communicate with computers 12 and market database 18 and receive and process data to stress test financial investments. In some embodiments, stress test module 16 may execute any suitable operating system such as IBM's, z/OS, MS-DOS, PC-DOS, MAC-OS, WINDOWS, UNIX, OpenVMS, or any other appropriate operating system, including future operating systems. The functions of stress test module 16 may be performed by any suitable combination of one or more servers or other components at one or more locations. In the embodiment where the modules are servers, the servers may be public or private servers, and each server may be a virtual or physical server. The server may include one or more servers at the same or at remote locations. Also, stress test module 16 may include any suitable component that functions as a server. In the illustrated embodiment, aggregation module 16 includes a network interface 30, a processor 32, and a memory 34.

Network interface 30 represents any suitable device operable to receive information from network 14, transmit information through network 14, perform suitable processing of the market data, communicate to other devices, or any combination of the preceding. For example, network interface 30 receives requests from computer 12 to perform stress testing on a portfolio that includes a plurality of investments. To perform the stress testing on the portfolio, network interface 30 may receive data from market database 18. Network interface 30 represents any port or connection, real or virtual, including any suitable hardware and/or software, including protocol conversion and data processing capabilities, to communicate through a LAN, WAN, or other communication system that allows stress test module 16 to exchange information with network 14, computers 12, market database 18, or other components of system 10.

Processor 32 communicatively couples to network interface 30 and memory 34, and controls the operation and administration of stress test module 16 by processing information received from network interface 30 and memory 34. Processor 32 includes any hardware and/or software that operates to control and process information. For example, processor 32 executes rules 36 to control the operation of stress test module 16. Processor 32 may be a programmable logic device, a microcontroller, a microprocessor, any suitable processing device, or any suitable combination of the preceding.

Memory 34 stores, either permanently or temporarily, data, operational software, or other information for processor 32. Memory 34 includes any one or a combination of volatile or non-volatile local or remote devices suitable for storing information. For example, memory 34 may include random access memory (RAM), read only memory (ROM), magnetic storage devices, optical storage devices, or any other suitable information storage device or a combination of these devices. While illustrated as including particular modules, memory 34 may include any suitable information for use in the operation of stress test module 16.

In the illustrated embodiment, memory 34 includes rules 36 and results 38. Rules 36 generally refer to logic, rules, standards, policies, limitations, tables, and/or other suitable instructions for processing the market data received from market database 18 and for processing the information received from computer 12. Rules 36 may include logic to process the market data to determine the viability of investments in various market conditions, manage the risk of investments in different market conditions, or other suitable logic to process the market data to facilitate the management of investments.

Market database 18 stores, either permanently or temporarily, data related to investments. Market database 18 includes any one or a combination of volatile or non-volatile local or remote devices suitable for storing information. For example, market database 18 may include RAM, ROM, magnetic storage devices, optical storage devices, or any other suitable information storage device or combination of these devices.

In the illustrated embodiment, market database stores index data 40, portfolio data 42, market data 43, and correlation factor 44. Index data 40 represents any suitable information related to various investment indices. For example, index data 40 includes the volatility of indices in various industry sectors and regional sectors. In an embodiment, index data 40 is calculated from historical data of each index. The volatility may be represented as a number. Portfolio data 42 represents any suitable information related to a portfolio of investments. As an example, portfolio data 42 includes the volatility of an entire portfolio of investments. In an embodiment, portfolio data 42 is calculated from historical data of the portfolio. A portfolio may include a wide range of investments from various industries. Additionally, the portfolio may include any suitable distribution of the plurality of investments. As another example, portfolio data 42 includes the volatility of each sub-portfolio within the portfolio of investments. Market data 43 represents information related to a market. As an example, market data 43 includes historical information about the volatility of a market, the returns of the market during various periods of time, or other suitable market information. Correlation factor 44 represents a value that provides a correlation between random variables. Correlation factor 44 may be predefined by a user of computer 12 and stored in market database 18 for retrieval. Alternatively, computer 12 may communicate correlation factor 44 to stress test module 16 when requesting stress testing of a portfolio. Market database 18 may include any suitable number of correlation factors 44 that allow for correlation of random variables. In an embodiment, correlation factor 44 changes based on market conditions.

In an exemplary embodiment of operation, a user interacts with computer 12a to request stress testing of a portfolio of investments. Stress testing allows system 10 to determine the impact of a future economic market event on the portfolio of investments. Using application 22, the user enters a request 50 on GUI 20. Request 50 may include a request for stress testing of one or more portfolios and may include parameters to facilitate the processing. For example, request 50 may include correlation factor 44. Request 50 may also include other criteria for the testing, or request 50 may include the criteria in which to provide the results. Request 50 may also include a stress multiplier. A stress test multiplier represents the ratio of relative changes between the portfolio and an index and is used to compensate for any inaccuracy of volatility estimates due to data limitations. In an embodiment, request 50 also includes the forward looking scenarios to use in the stress testing.

Stress test module 16 receives request 50 and interacts with market database 18 to determine market information associated with the one or more portfolios in request 50. To determine the market information to retrieve, stress test module 16 divides the portfolio into sub-portfolios. In an embodiment, the sub-portfolios are related to a particular industry and region. Each sub-portfolio is associated with a market index. In an embodiment, stress test module 16 communicates request 52 to market database 18 to determine market information associated with each sub-portfolio. By gathering data from market database 18 and receiving a future market scenario from computer 12, stress test module 16 is able to use future market predictions to determine the potential performance of the sub-portfolios and the entire portfolio under certain market conditions.

Stress testing module 16 receives market information 54 from market database 18. In the illustrated embodiment, market information 54 includes index data 40, portfolio data 42, market data 43, and correlation factor 44. Index data 40 is associated with the market index of the sub-portfolio, portfolio data 42 is associated with the entire portfolio, and market data 43 is associated with the market.

Stress test module 16 processes market information 54 according to rules 36. Processing market information 54 allows for stress test module 16 to test the portfolio in request 50, which facilitates the determination of the profit/loss value of the portfolio. In an embodiment, stress test module 16 first translates the future market scenario to shocks of each market index. For example,

Shock (market index)=Calculated Measurement (industry index)*Shock (market scenario).

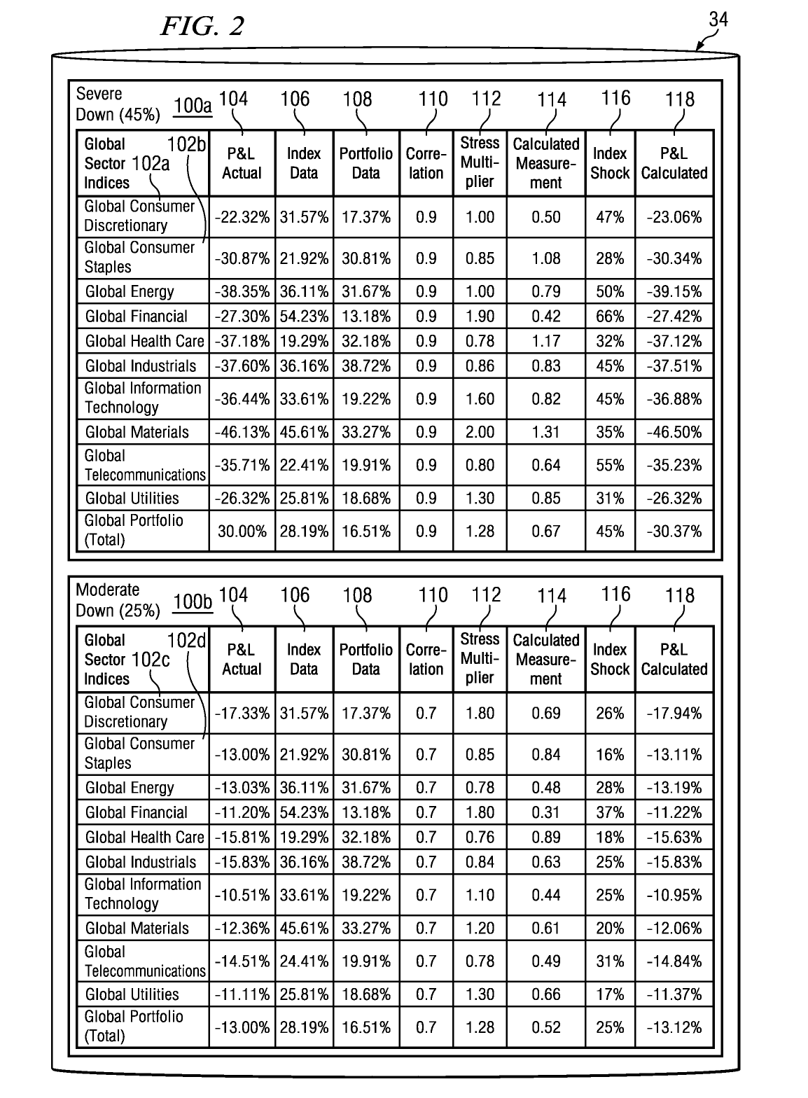

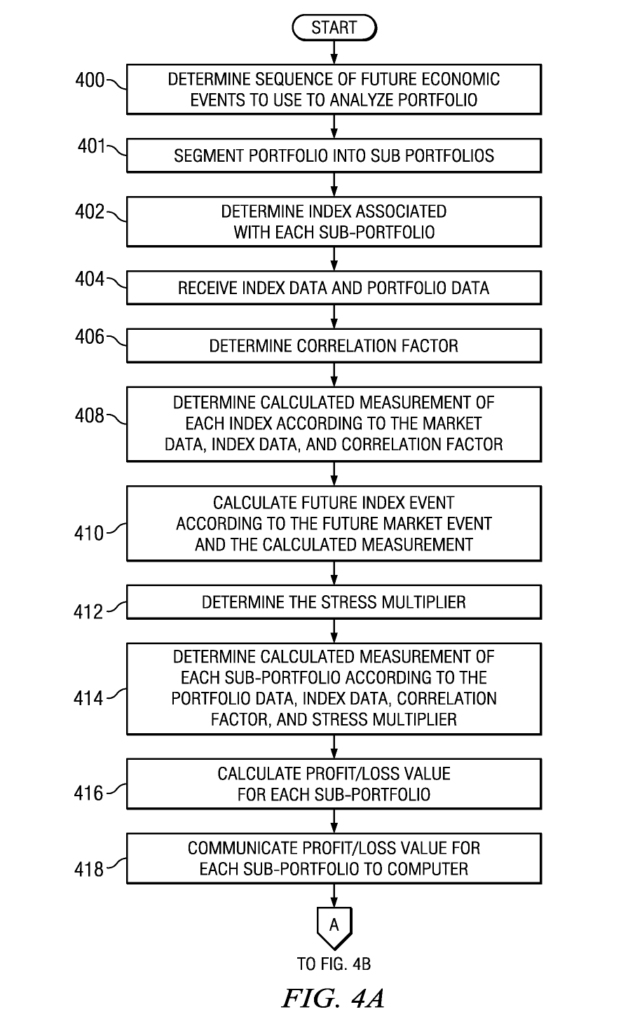

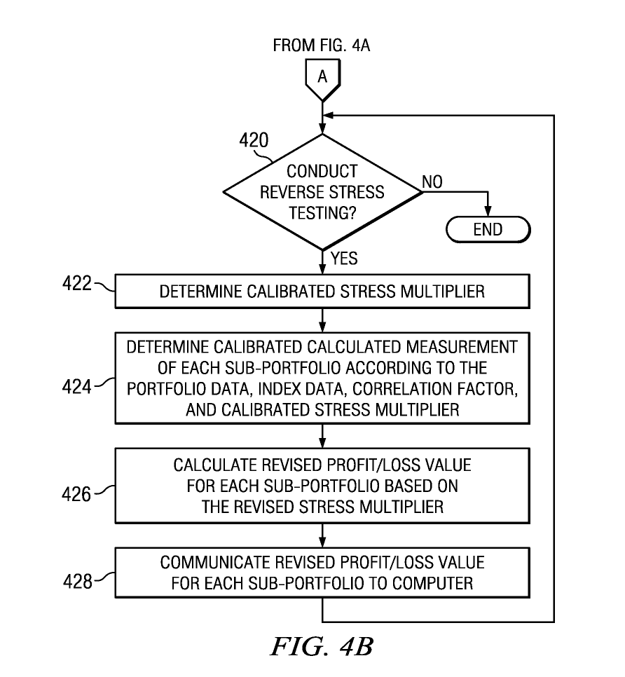

Calculated measurement is further described with respect to FIGS. 2 and 4. Stress test module 16 then determines the profit/loss value of each sub-portfolio with respect to the shock of the associated market index. For example,

P/L(sub-portfolio)=Calibrated Calculated Measurement (sub-portfolio)*Shock (market index)*Carrying-Value (sub-portfolio).

The calibrated calculated measurement and carrying value are further described with respect to FIG. 4. Stress test module 16 determines the profit/loss value of the entire portfolio by summing up the profit/loss values of each of the sub-portfolios. For example,

P/L(portfolio)=P/L(sub-portfolio #1)+ . . . P/L(sub-portfolio #n),

where n is the number of sub-portfolios in the portfolio. Stress test module 16 may format the results for presentation to the user. Stress test module 16 communicates results 56 to computer 12a for display on GUI 20a. Results 56 may be used to report risk of a portfolio, manage investments, internal and regulatory reporting or any other suitable day-to-day operation of an enterprise.

A component of system 10 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computer-readable medium or any other suitable tangible medium, and may perform operations when executed by a computer. Certain logic, such as a processor, may manage the operation of a component. Examples of a processor include one or more computers, one or more microprocessors, one or more applications, and/or other logic.

Modifications, additions, or omissions may be made to system 10 without departing from the scope of the invention. For example, stress test module 16 may receive correlation factor 44 from computer 12 rather than retrieving correlation factor 44 from market database 18. Additionally, system 10 may include any number of computers 12, networks 14, stress test modules 16, and market databases 18. Any suitable logic may perform the functions of system 10 and the components within system 10.

FIG. 2 illustrates a particular embodiment of a memory 34 in stress test module 16 that stores calculated information and stores information used to facilitate stress testing. Results 36 may be stored in stress test module memory 34 or may be stored in an external network storage device. Stress test module memory 34 stores results for each test scenario performed. The testing results may be stored in an organized manner within memory 34. In an embodiment, memory 34 organizes results 36 into separate event result charts 100. In the illustrated embodiment, event result chart 100a represents the results in a severe down market that is down 45%. Event result chart 100b represents the results in a moderate down market that is down 25%. Each result chart 100 may organize the information into index records 102. Each index record 102 is related to a sub-portfolio, and each index record 102 may have associated information provided in specific fields.

In certain embodiments, index record 102 may include the following fields: actual profit/loss value field 104, index data field 106, portfolio data field 108, correlation field 110, stress multiplier field 112, calculated measurement field 114, index shock field 116, and calculated profit/loss value field 118. Actual profit/loss value field 104 includes the actual profit/loss value of a particular portfolio under the particular market condition shown in result chart 100. In the illustrated embodiment, the actual profit/loss value is represented as a percentage. In other embodiments, the actual profit/loss value may be represented as any suitable number. Index data field 106 includes the volatility of the associated index under the tested market condition. In the illustrated embodiment, the index volatility is represented as a percentage. Portfolio data field 108 includes the volatility of the portfolio under the tested market condition. In the illustrated embodiment, the portfolio volatility is represented as a percentage.

Correlation field 110 includes the correlation factor to be used to test the portfolio under the particular market condition. In the illustrated embodiment, the correlation factor is a number that is the same for each tested index. As discussed above, the correlation factor may be adjusted depending on the particular economic condition to analyze. Stress multiplier field 112 includes the stress multiplier to be used to test the portfolio. Because a limited amount of data is available on the profit/loss of a portfolio, a statistical inference on the volatilities from a subset of data between portfolio data 42 and index data 40 is used. The stress multiplier represents the ratio of relative changes between the portfolio and the index and is used to compensate for any inaccuracy of volatility estimates due to data limitations. In an embodiment, once sufficient data has been collected to consider the correlation calculation statistically relevant, the stress testing method may be implemented using the calculated correlations and volatility numbers without a stress multiplier. In the illustrated embodiment, each index has a different stress multiplier. In other embodiments, the same stress multiplier may be applied to each index.

Calculated measurement field 114 includes the calculated measurement that is used to test the portfolio. In an embodiment, the calculated measurement is the Beta factor of the Capital Asset Pricing Model (CAPM), which is used to analyze returns to determine how the return from investment varies in relationship to the market. The calculated measurement represents the sensitivity of the price of a particular asset to changes in the market as a whole. For example, if the shares of an asset have a calculated measurement of 0.8, it implies that on average, the share price will change by 0.8% if there is a 1% change in the market. As shown in the illustrated embodiment, the calculated measurement is different for each industry. The calculated measurement also measures the volatility and correlation between investment return and market return.

Index shock field 116 includes the value of the particular index based on an economic shock. For example, in the event of a shock, an index's value will change. Index shock field 116 includes the value of the index in light of the economic shock. In the illustrated embodiment, the index shock is represented as a percentage. In other embodiments, the index shock may be represented as any suitable number. Calculated profit/loss value field 118 includes the calculated profit/loss value of a particular portfolio based on the stress testing under the particular market condition shown in result chart 100. In the illustrated embodiment, the calculated profit/loss value is represented as a percentage. In other embodiments, the calculated profit/loss value may be represented as any suitable number. Each field is included for each index record 102 in results chart 100.

When performing the stress testing on each portfolio, stress test module 16 may use information from various fields of index record 102. Other fields may be populated and included within results charts 100 at the completion of the stress testing. For example, stress test module 16 populates calculated profit/loss value field 118 upon determining the stress multiplier necessary to match the actual profit/loss value of the particular portfolio.

In the illustrated embodiment, row 102a illustrates the behavior of the Global Consumer Discretionary index associated with a particular portfolio in a severe down market of 45%. Row 102b illustrates the behavior of the Global Consumer Staples index associated with the particular portfolio in a severe down market of 45%. Row 102c illustrates the behavior of the Global Consumer Discretionary index associated with the particular portfolio in a moderate down market of 25%. Row 102d illustrates the behavior of the Global Consumer Staples index associated with the particular portfolio in a moderate down market of 25%.

In each row 102, the variables used to calculate the profit/loss value of the portfolio are shown in various fields. Each row 102 has index data and portfolio data. As illustrated, the index data and portfolio data for each index are the same in results charts 100a and 100b. Therefore, this information does not change with respect to the economic condition being tested. The correlation factor is the same for each index in a particular market condition. For example, the correlation factor for the severe down market condition is 0.9 and the correlation factor for the moderate down market condition is 0.7. The stress multiplier is provided for each index under each market condition and may be used to determine the calculated measurement of each index. In an embodiment, the calculated measurement is first determined using the index data, portfolio data, and correlation factor. To calibrate the calculated measurement, stress test module 16 may use the stress multiplier. The impact of the economic condition on each index is also shown, along with the calculated profit/loss value of each portfolio. In the illustrated embodiment, the calculated profit/loss value of the portfolio shown in row 102a is −23.06% and the calculated profit/loss value of the portfolio shown in row 102b is −30.34%. For row 102c, the calculated profit/loss value of the portfolio is −17.94%, and for row 102d, the calculated profit/loss value of the portfolio is −13.11%.

Modifications, additions, or omissions may be made to memory 34. For example, any suitable component within system 10 may include stress test memory 34. As another example, each results chart 100 may include any suitable number and type of records and fields based on the stress testing. As yet another example, the plurality of results charts 100 may be organized into folders according to any suitable criteria. For example, results charts 100 may be organized according to the market condition being tested, calendar quarter, or fiscal quarter.

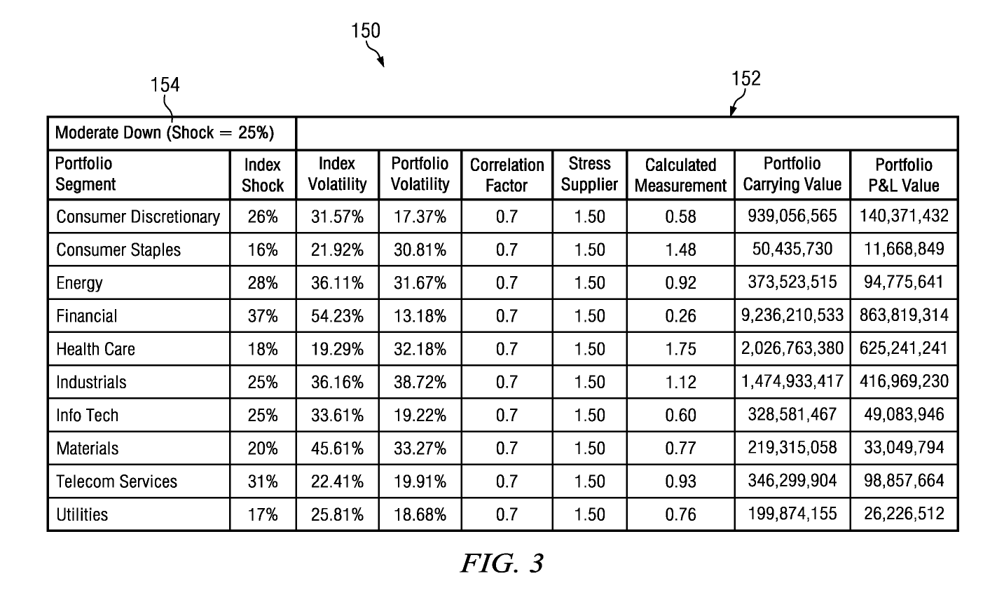

FIG. 3 illustrates an example screenshot 150 for displaying results of the stress testing. Screenshot 150 may be one embodiment of a user interface in which a user views the results of the stress testing received from stress test module 16. The example screenshot 150 illustrates portfolio information under a moderate down scenario.

Graph 152 illustrates the results of the stress testing on a portfolio during an economic shock of 25%. Bar 154 represents the particular event for which the data is applicable. As shown in bar 154, a moderate down economy is a 25% down market. Information that is used to stress test the portfolio is displayed on graph 152 along with the results of the analysis, which is illustrated as the impact on the profit/loss value of the portfolio.

In the illustrated embodiment, the portfolio analysis is illustrated according to portfolio segment. Each segment is separately displayed on graph 152. Each portfolio segment includes the following information to inform the user of the variables used in the stress testing: index shock, index volatility, portfolio volatility, correlation factor, stress multiplier, calculated measurement, portfolio carrying value, and portfolio profit/loss value. With the information, a user may analyze the financial stability and health of a portfolio and may perform additional testing on the portfolio under different market conditions.

As discussed above, a user may initiate the stress testing on a portfolio. When requesting the testing, the user may specify how the results should appear. For example, to receive this screenshot 150, the user may have specified that the results be displayed by portfolio segment and the variables used in the testing be displayed also.

The user may change which variables appear on screenshot 150. As another example, the user may change particular variables and request additional testing be performed. For example, the user may update the stress multiplier based on historical data about the portfolio to receive different results. The user also may request that the results be displayed in any suitable format, such as a bar graph, a pie graph, or a line chart.

FIGS. 4A-4B illustrate a flowchart for stress testing financial investments. The method begins in step 400 where stress test module 16 determines a sequence of future market events to use to analyze a portfolio. Stress test module 16 receives a request that indicates the portfolio to analyze and the future market scenario to consider. Determining the future market impacts the amount of stress under which the portfolio is tested.

At step 401, the portfolio to test is separated into sub-portfolios. The portfolio is divided based on industry and region. The particular distribution of each sub-portfolio in the portfolio is also determined. For example, the portfolio may be divided into sub-portfolios based on financials, healthcare, industrials, consumer discretionary, energy, information technology, telecommunications, consumer staples, materials, and utilities. The portfolio may also be divided based on region, such as the United States of America, Europe, Asia, Japan, or any other region. In another embodiment, each sub-portfolio can be divided further into sub-sub-portfolios. For example, the financials sub-portfolio may be separated into hedge funds, real estate, other funds, and other directs.

At step 402, stress test module 16 determines the index associated with each sub-portfolio. Each sub-portfolio is then matched with a market index associated with the particular industry and/or particular region. For example, the financials sub-portfolio may be associated with the S&P Global 1200 Financial Sector Index, the healthcare sub-portfolio may be associated with the S&P Global 1200 Healthcare Sector Index, the industrials sub-portfolio may be associated with the S&P Global 1200 Industrials Sector Index, the consumer discretionary sub-portfolio may be associated with the S&P Global 1200 Consumer Discretionary Index, the energy sub-portfolio may be associated with the S&P Global 1200 Energy Sector Index, the information technology sub-portfolio may be associated with the S&P Global 1200 Information Technology Sector Index, the telecommunications sub-portfolio may be associated with the S&P Global 1200 Telecommunication Services Sector Index, the consumer staples sub-portfolio may be associated with the S&P Global 1200 Consumer Staples Sector Index, the materials sub-portfolio may be associated with the S&P Global 1200 Materials Index, and the utilities sub-portfolio may be associated with the S&P Global 1200 Utilities Index.

Once the portfolio is separated into sub-portfolios and the sub-portfolios are associated with particular indices, stress test module 16 receives index data 40 and portfolio data 42 from market database 18 at step 404. Index data 40 represents the volatility of each index associated with the sub-portfolios. Portfolio data 42 represents the volatility of the portfolio. At step 406, correlation factor 44 is determined for a given market event. In an embodiment, stress test module 16 receives correlation factor 44 from computer 12 or market database 18.

At step 408, stress test module 16 determines the calculated measurement of each index according to market data 46, index data 40, and correlation factor 44. The calculated measurement can be used to translate the impact of a market shock to individual shocks of each index. In particular, stress test module 16 applies the following to obtain the calculated measurement of each index:

βi,m=(σ(i)/σ(m)*ρ(i,m)

where σ(i) is index volatility stored as index data 40, σ(m) is market volatility stored as market data 46, and ρ(i,m) is the correlation factor between the index and the market.

The future index event is then calculated, at step 410, according to the future market event and the calculated measurement. The future index event represents the effect of the particular market condition on the index. The future index event may be calculated using the following equation:

R(i)=β_{i,m}*R(m)

where R(m) is the economic shock on the market and β_{i,m} is the calculated measurement of the index with respect to the market.

Stress test module 16 determines the stress multiplier at step 412 to facilitate additional calculations. In an embodiment, stress test module 16 receives the stress multiplier from computer 12. The stress multiplier is used to determine the calculated measurement of the sub-portfolio to improve the testing accuracy because the stress multiplier is not bounded by either the volatility of the index or the volatility of the portfolio. In an embodiment, a different stress multiplier is provided for each index. At step 414, stress test module 16 determines a calculated measurement of each sub-portfolio according to portfolio data 42, index data 40, correlation factor 44, and the stress multiplier. The calculated measurement of each sub-portfolio is determined according to the following:

β_{ik,pk}=λₖ*(σ(iₖ)/σ(pₖ))*ρ(iₖ,pₖ)

for k=1 through n, where n is the number of portfolio segments and λₖ is the stress multiplier of the kth sub-portfolio segment.

The profit/loss value of each sub-portfolio is then calculated at step 416 using the following equation:

P/L Value (Sub-Portfolio)=β_{ik,pk}*R(i)*Sub-Portfolio Carrying Value.

The index carrying value represents an accounting measure of value, which is the value of an asset based on the figures on a balance sheet. For assets, the value is based on the original cost of the asset less any depreciation, amortization, impairment costs made against the asset, fair value adjustments, mark to market adjustments, and/or equity pickups. In an embodiment, the carrying value of an asset is the value of the asset at the beginning of each quarter or stress calculation period. As shown in the above equation, the calculated measurement is used to determine the profit/loss value of each sub-portfolio. Upon calculating the profit/loss value for each sub-portfolio, stress test module 16 may communicate the profit/loss value for each sub-portfolio to computer 12 for display at step 418.

At step 420, stress test module 16 determines whether to conduct reverse stress testing. A user of computer 12 may request reverse stress testing when the initial profit/loss value calculations for the indices are received. In an embodiment, reverse stress testing may be used to calibrate the stress multiplier to an actual profit/loss experienced during an historical period. In another embodiment, reverse stress testing may be used to calibrate the stress multiplier to a hypothetical profit/loss. Therefore, a user is able to further manipulate the data for further analysis. Reverse stress testing may also be used to reverse engineer what the market shock would be to produce a specific profit/loss move. This technique may be particularly useful for illiquid assets when the data is very limited. If stress test module 16 determines not to conduct reverse stress testing, the method ends. Otherwise, the method continues from step 422.

At step 422, stress test module 16 determines a calibrated stress multiplier that is used for the reverse stress testing. In an embodiment, a user determines the calibrated stress multiplier, and computer 12 communicates the calibrated stress multiplier to stress test module 16. At step 424, stress test module 16 determines the calibrated calculated measurement of each sub-portfolio according to portfolio data 42, index data 40, correlation factor 44, and the calibrated stress multiplier. Using the calibrated calculated measurement of the sub-portfolio, stress test module 16 calculates the revised profit/loss value for each sub-portfolio at step 426. The revised profit/loss value for each sub-portfolio may be communicated at step 428 to computer 12 for further analysis. The method may then continue from step 420, and stress test module 16 determines whether to conduct reverse stress testing.

Modifications, additions, or omissions may be made to the flowchart. For example, stress test module 16 may also calculate the profit/loss value of the entire portfolio of investments and communicate the calculation to computer 12. To determine the profit/loss value of the portfolio, stress test module 16 calculates the sum of the sub-portfolio profit/loss values. Stress test module 16 may also determine the return of the portfolio and may communicate that information to computer 12. To determine a portfolio's return, the sum of the profit/loss values of the sub-portfolios is divided by the total portfolio value. Additionally, steps in FIG. 4 may be performed in parallel or in any suitable order.

Certain embodiments of the invention may provide one or more technical advantages. A technical advantage of one embodiment includes considering future economic market predictions to determine the performance of financial investments under certain market conditions. By considering future prediction information, an enterprise is able to more accurately assess future behavior of a set of financial investments. Another technical advantage of an embodiment includes considering the volatility of indices to more accurately forecast how a portfolio will move in relation to market factors. Additionally, a calculated measurement of the Capital Asset Pricing Model will be used to translate forward looking scenarios and to more accurately forecast the behavior of the tested portfolio. Yet another technical advantage of an embodiment provides a way of performing reverse stress testing on the financial investments to determine the market conditions under which the investment portfolio may be vulnerable. Therefore, information may be calibrated to change the determined profit/loss value of financial investments. Another technical advantage of an embodiment includes considering each portion of the portfolio in the analysis rather than considering the entire portfolio as a whole. To perform the stress testing, the portfolio of financial investments is divided into sub-portfolios to capture the risk more accurately with respect to each market index, and the sub-portfolios are separately analyzed. The analyzed sub-portfolios are then combined to determine the performance of the entire portfolio.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. A system for stress testing financial investments, comprising:
a processor operable to:
determine a sequence of future economic market events to use to analyze a portfolio;
determine indices associated with the portfolio;
a network interface communicatively coupled to the processor and operable to:
receive portfolio data associated with the portfolio, wherein the portfolio data indicates the volatility of the portfolio during a predefined time period;
determine a correlation factor associated with the future economic market; and
the processor is further operable to:
determine a calculated measurement of each index according to the market data, the index data, and the correlation factor; and
calculate a future index event according to the future market event and the calculated measurement of the index.

2. The system of claim 1, wherein the processor is further operable to:
segment the portfolio into sub-portfolios; and
map each sub-portfolio to a market index, wherein the market index is associated with an industry and a region.

3. The system of claim 2, wherein the processor is further operable to:
determine a stress multiplier associated with the future market event; and
determine a calculated measurement of each sub-portfolio according to the portfolio data, the index data, the correlation factor, and the stress multiplier.

4. The system of claim 3, wherein:
the processor is further operable to calculate a profit/loss value for each sub-portfolio in the portfolio according to the future index event; and
the network interface is further operable to communicate the profit/loss value for each sub-portfolio in the portfolio to a computer.

5. The system of claim 4, wherein the processor is further operable to calculate the profit/loss value according to the calibrated measurement of the sub-portfolio, a carrying value of the index, and a future index event.

6. The system of claim 2, wherein:
the processor is further operable to determine whether to conduct reverse stress testing;
if it is determined to conduct reverse stress testing:
the network interface is further operable to determine a calibrated stress multiplier; and
the processor is further operable to determine a calibrated calculated measurement of each sub-portfolio according to the portfolio data, the index data, the correlation factor, and the calibrated stress multiplier.

7. The system of claim 6, wherein:
the processor is further operable to calculate a revised profit/loss value for each sub-portfolio in the portfolio according to the future index event, wherein calculating the revised profit/loss value for each sub-portfolio comprises calculating the profit/loss value according to the calibrated calculated measurement of the sub-portfolio, a carrying value of the index, and a future index event; and
the network interface is further operable to communicate the profit/loss value for each sub-portfolio in the portfolio to a computer.

8. A method for stress testing financial investments, comprising:
determining a sequence of future economic market events to use to analyze a portfolio;
determining indices associated with the portfolio;
receiving portfolio data associated with the portfolio, wherein the portfolio data indicates the volatility of the portfolio during a predefined time period;
receiving index data associated with each index of the economic market, wherein the index data indicates the volatility of each index during the predefined time period;
determining a correlation factor associated with the future economic market;
determining, using a processor, a calculated measurement of each index according to the market data, the index data, and the correlation factor; and
calculating, using the processor, a future index event according to the future market event and the calculated measurement of the index.

9. The method of claim 8, wherein determining the indices associated with the portfolio comprises:
segmenting the portfolio into sub-portfolios; and
mapping each sub-portfolio to a market index, wherein the market index is associated with an industry and a region.

10. The method of claim 9, further comprising:
determining a stress multiplier associated with the future market event;
determining, using the processor, a calculated measurement of each sub-portfolio according to the portfolio data, the index data, the correlation factor, and the stress multiplier.

11. The method of claim 10, further comprising:
calculating, using the processor, a profit/loss value for each sub-portfolio in the portfolio according to the future index event; and
communicating the profit/loss value for each sub-portfolio in the portfolio to a computer.

12. The method of claim 11, wherein calculating a profit/loss value for each index comprises calculating the profit/loss value according to the calibrated measurement of the sub-portfolio, a carrying value of the index, and a future index event.

13. The method of claim 9, further comprising:
determining whether to conduct reverse stress testing;
if it is determined to conduct reverse stress testing:
determining a calibrated stress multiplier; and
determining, using the processor, a calibrated calculated measurement of each sub-portfolio according to the portfolio data, the index data, the correlation factor, and the calibrated stress multiplier.

14. The method of claim 13, further comprising:
calculating, using the processor, a revised profit/loss value for each sub-portfolio in the portfolio according to the future index event, wherein calculating the revised profit/loss value for each sub-portfolio comprises calculating the profit/loss value according to the calibrated calculated measurement of the sub-portfolio, a carrying value of the index, and a future index event; and
communicating the profit/loss value for each sub-portfolio in the portfolio to a computer.

15. Non-transitory computer readable medium comprising logic, the logic, when executed by a processor, operable to:
determine a future economic market event to use to analyze a portfolio;
determine indices associated with the portfolio;
receive portfolio data associated with the portfolio, wherein the portfolio data indicates the volatility of the portfolio during a predefined time period;
receive index data associated with each index of the economic market, wherein the index data indicates the volatility of each index during the predefined time period;
determine a correlation factor associated with the future economic market;
determine a calculated measurement of each index according to the market data, the index data, and the correlation factor; and
calculate a future index event according to the future market event and the calculated measurement of the index.

16. The computer readable medium of claim 15, wherein determining the indices associated with the portfolio comprises:
segmenting the portfolio into sub-portfolios; and
mapping each sub-portfolio to a market index, wherein the market index is associated with an industry and a region.

17. The computer readable medium of claim 16, the logic further operable to:
determine a stress multiplier associated with the future market event;
determine, using the processor, a calculated measurement of each sub-portfolio according to the portfolio data, the index data, the correlation factor, and the stress multiplier.

18. The computer readable medium of claim 17, the logic further operable to:
calculate a profit/loss value for each sub-portfolio in the portfolio according to the future index event; and
communicate the profit/loss value for each sub-portfolio in the portfolio to a computer.

19. The computer readable medium of claim 18, wherein calculating a profit/loss value for each index comprises calculating the profit/loss value according to the calibrated measurement of the sub-portfolio, a carrying value of the index, and a future index event.

20. The computer readable medium of claim 16, the logic further operable to:
determine whether to conduct reverse stress testing;
if it is determined to conduct reverse stress testing:
determine a calibrated stress multiplier; and
determine a calibrated calculated measurement of each sub-portfolio according to the portfolio data, the index data, the correlation factor, and the calibrated stress multiplier.
